(19) United States
(12) Patent Application Publication
(10) Pub. No.: US 2010/0093393 A1
(43) Pub. Date: Apr. 15, 2010

(54) Systems and Methods for Music Recognition

(76) Inventor: Nils Graef, Santa Clara, CA (US)

Correspondence Address: Hamilton,DeSanctis & Cha (LSI), 8601 W. CROSS DRIVE, F5-301, LITTLETON, CO, 80123, US

(21) Appl. No.: 12/519,523

(22) PCT Filed: Apr. 23, 2007
(86) PCT No.: PCT/US07/67185

§ 371 Date: Jun. 17, 2009

(51) Int. Cl. H04M 1/00; G06F 17/00; G10L 15/00

(52) U.S. Cl. 455/556.1; 700/94; 704/270; 704/E15.001

(57) ABSTRACT

Various systems and methods for music recognition are disclosed herein. For example, music recognition devices are disclosed that include a data receiver that is operable to receive a data signal incorporating an identification of a currently playing song. The devices further include a memory and a processor. The memory includes instructions executable by the processor to: parse the data signal and to cause the identification to be stored to the memory. At least a portion of the identification is maintained in the memory after the currently playing song has terminated.

### BACKGROUND OF THE INVENTION

The present invention is related to music recognition, and more particularly to systems and methods for identifying music based on various pieces of information associated with the identified music.

Listeners are exposed to music in a number of circumstances including, for example, while at home listening to a stereo, in an automobile, and at restaurants and bars. In many cases, the listener will find a tune repeating in their minds after they have heard it. In such cases, the listener may desire to know the name and artist of the tune so that they may purchase it. For this purpose, one or more music recognition systems have been developed.

Turning to FIG. 1, an example of one such music recognition system 100 is shown. Music recognition system 100 includes a music source 110 that may be a CD player, a radio or the like. Music source 110 plays one or more songs 125 that are heard by one or more listeners 130. One of listeners 130 may use a cellular telephone 150 to connect to a music recognition service 140 via a cellular telephone network 170. Once connected, cellular telephone 150 is exposed to song 125, and using the microphone of cellular telephone 150 song 125 is made available to music recognition service 140. In turn, music recognition service 140 applies a recognition algorithm to a portion of song 125, and compares patterns in the song to a number of known patterns until a match is found. An identification of the matching tune is then sent to the cellular telephone as data 147. The listener may then use the received data to identify song 125.

While the aforementioned approaches are useful, they rely on a listener's immediate access to a cellular telephone, availability to interrupt current activities, and quality of audio transmission. However, in many cases a listener either does not have immediate access to a phone or cannot interrupt their current activity. Furthermore, a listener may not be willing to pay a per access fee to use such systems, or to pay for text messaging that may be used to relay the song and artist to the listener once identified. Yet further, re-transmitting a song via a communication network may infringe copyright in the re-transmitted song. Finally, the audio transmission may be affected by the ambient noise in a user's immediate environment and further distorted by the music receiver and/or cellular telephone network. In this case, the song may not be recognized by the music identification service.

Hence, for at least the aforementioned reasons, there exists a need in the art for advanced systems and methods for music recognition.

### BRIEF SUMMARY OF THE INVENTION

The present invention is related to music recognition, and more particularly to systems and methods for identifying music based on various pieces of information associated with the identified music.

Various embodiments of the present invention provide music recognition devices. Such music recognition devices include a data receiver that is operable to receive a data signal incorporating an identification of a currently playing song. The devices further include a memory and a processor. The memory includes instructions executable by the processor to: parse the data signal and to cause the identification to be stored to the memory. At least a portion of the identification is maintained in the memory after the currently playing song has terminated. In some instances of the aforementioned embodiments, the identification includes a song title and artist. In various cases, the identification further includes a location of the music source. In yet other cases, the identification further includes a short portion of the song that may be used along with the title for the purpose of allowing the user to identify the song. In various cases, the data receiver is a wireless receiver. Such a wireless receiver may be capable of, but is not limited to, receiving information via a Bluetooth or a WiFi (802.11 protocol) network.

In some instances of the aforementioned embodiments, the music recognition device includes location circuitry operable to provide a location of the music recognition device, and the location of the music recognition device is stored in relation to the identification. In some cases of the aforementioned embodiments, the memory further includes instructions executable by the processor to store a time stamp in relation to the identification. The time stamp indicates an approximate time when the currently playing song was playing. In one or more instances, the music recognition device is incorporated into an electronic device. Such an electronic device may be, but is not limited to, a cellular telephone, a personal digital assistant, a laptop computer, a digital music player, and a digital video player.

Other embodiments of the present invention provide music recognition systems. Such systems include a music source. The music source includes a speaker and a wireless data transmitter. The music source is operable to transmit a data signal via the wireless data transmitter, and to transmit an audio signal via the speaker. The audio signal is a currently playing song, and the data signal includes an identification of a currently playing song. In some instances of the aforementioned embodiments, the music source may be, but is not limited to, a digital music player, or a radio receiver. In various instances of the aforementioned embodiments, identification includes a song title and artist. In some cases, the identification further includes a location of the music source.

Yet other embodiments of the present invention provide methods for music recognition. The methods include providing a music recognition device. The music recognition device includes a data receiver, and a memory. The methods further include receiving a data signal at the data receiver. The data signal includes an identification of a currently playing song. The methods further include storing at least a portion of the identification to the memory, and maintaining the portion of the identification in the memory after the currently playing song has stopped. In some cases, the methods further include accessing the portion of the identification from the memory, and using a portion of the identification to order a music media including a song identified by the identification after the currently playing song has stopped.

Additional embodiments of the present invention provide cellular telephones that include a data receiver, a processor and a memory. The data receiver is operable to receive a data signal that includes an identification of a currently playing song. The memory includes instructions executable by the processor to parse the data signal and to cause the identification to be stored to the memory. Further, the memory includes a portion allocatable to receive at least a portion of the identification and to maintain the portion of the identification after the currently playing song has terminated.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a prior art music recognition system;

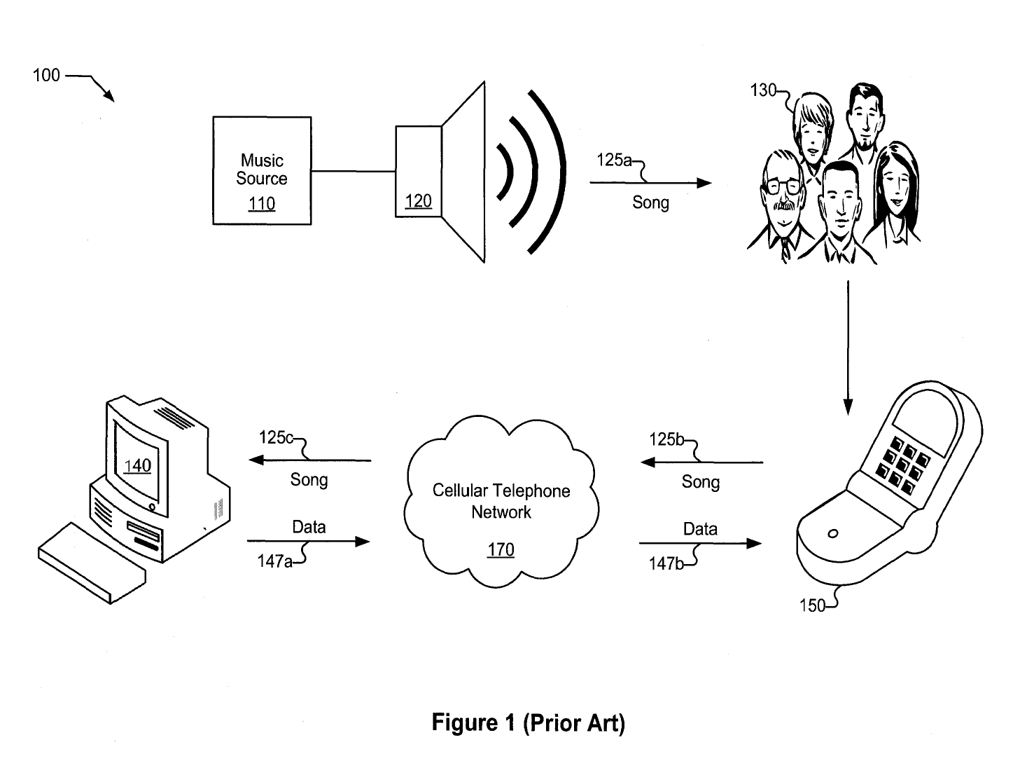

FIG. 2a shows a music recognition system in accordance with one or more embodiments of the present invention;

FIG. 2b shows a block diagram of a mobile music recognition device in accordance with various embodiments of the present invention;

FIG. 2c is a flow diagram depicting a method for operating a music recognition device in accordance with various embodiments of the present invention;

FIG. 3 shows a music recognition system in accordance with some embodiments of the present invention that is further augmented to allow use of music related services;

FIG. 4 is a flow diagram of a method for operating a music recognition system in accordance with some embodiments of the present invention; and

FIG. 5 is a flow diagram depicting some additional detail of the method discussed in FIG. 4.

### DETAILED DESCRIPTION OF THE INVENTION

The present invention is related to music recognition, and more particularly to systems and methods for identifying music based on various pieces of information associated with the identified music.

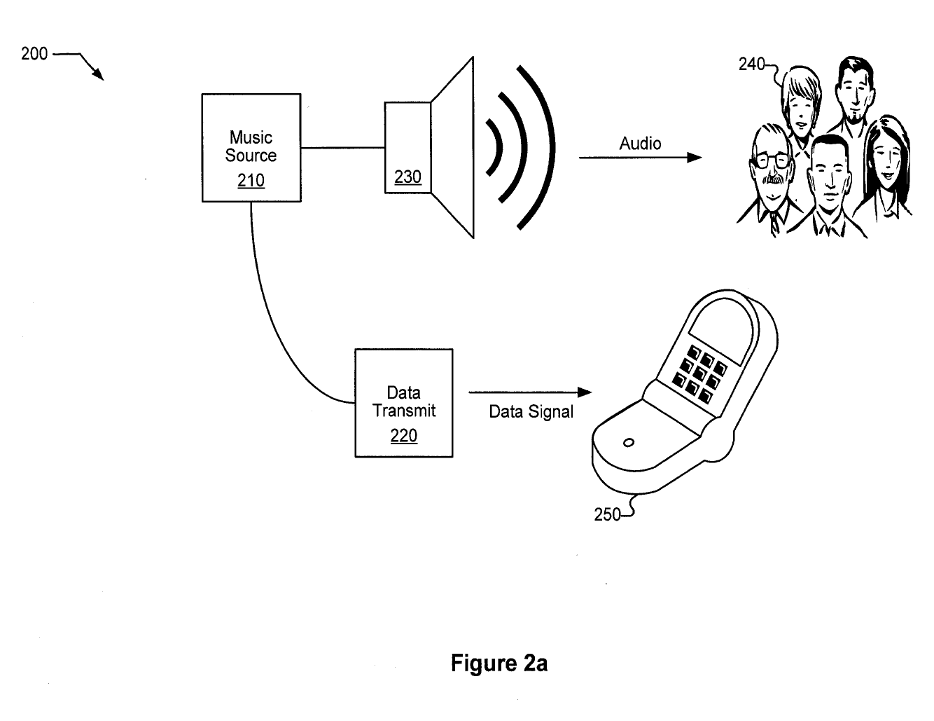

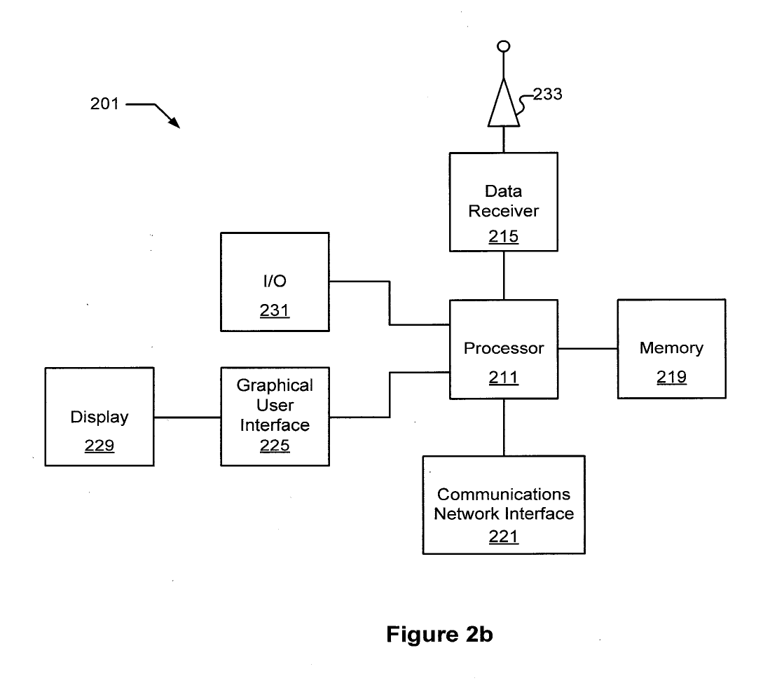

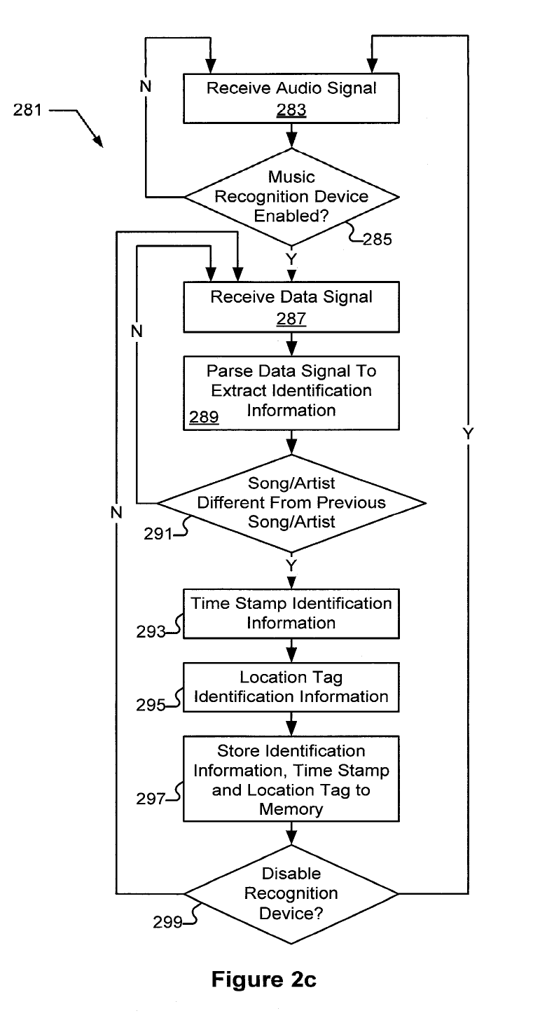

Turning to FIG. 2a, a music recognition system 200 in accordance with one or more embodiments of the present invention is shown. Music recognition system 200 includes a music source 210 that is capable of transmitting an audio signal of a currently playing song via a speaker 230, and a digital signal carrying an identification of the currently playing song via a data transmitter 220. Music source 210 may include, but is not limited to, a radio frequency tuner, a compact disk player, an MP3 player, combinations of the aforementioned, and/or the like. In one particular embodiment of the present invention, music source 210 is a satellite radio receiver. Based on the disclosure provided herein, one of ordinary skill in the art will recognize a myriad of music sources that may be used in relation to one or more embodiments of the present invention. The audio signal from speaker 230 may be transmitted such that it may be enjoyed by one person or a group of people 240 that may be located in a public or private location.

Data transmitter 220 may be any transmitter capable of disseminating informational messages (i.e., a data signal) via a wireless network. Thus, for example, data transmitter 220 may be a Bluetooth transmitter that is capable of disseminating information via a Bluetooth protocol network. In other cases, data transmitter 220 may be a WiFi transmitter that is capable of disseminating information via a wireless network that is 802.11 compliant. Based on the disclosure provided herein, one of ordinary skill in the art will recognize a variety of data transmitters and network protocols that may be used in relation to one or more embodiments of the present invention.

The data signal from data transmitter 220 is transmitted such that it may be received by one or more music recognition devices 250 that are located within range of the signal. Such music recognition devices 250 include capability to receive the data signal and to parse the identification of the currently playing song from the data signal. As previously discussed, the data signal may be transmitted via a particular wireless network protocol. In such cases, music recognition device 250 would include an interface allowing it to receive data via the particular protocol. In some cases, music recognition device 250 is a consumer electronic device that has been modified to perform one or more music recognition functions. Thus, music recognition device 250 may be incorporated in, for example, a cellular telephone, a personal digital assistant, a laptop computer, a digital music player, and a digital video player. Based on the disclosure provided herein, one of ordinary skill in the art will recognize a variety of consumer electronic devices in which music recognition device 250 may be incorporated. By incorporating music recognition device 250 with another common consumer electronic device, a user is not required to carry an additional device to receive the music recognition abilities discussed herein.

Turning to FIG. 2b, a block diagram of a mobile music recognition device 201 in accordance with one or more embodiments of the present invention is depicted. Mobile music recognition device 201 may be used in place of music recognition device 250 of FIG. 2a. Music recognition device 201 includes a processor 211 that is communicably coupled to a memory 219. Processor 211 may be any device capable of executing one or more instructions maintained in memory 219 to cause music recognition device 201 to perform a desired function. Memory 219 may be volatile or non-volatile memory, or some combination thereof. Thus, for example, memory 219 may include a hard disk drive, a bank of random access memory, and a cache. Based on the disclosure provided herein, one of ordinary skill in the art will recognize a variety of memory types and memory architectures that may be utilized in accordance with the various embodiments of the present invention.

Music recognition device 201 further includes a data receiver 215 that is communicably coupled to an antenna 233. As discussed above, data receiver 215 may be any circuit known in the art that is capable of receiving data via a wireless network. Thus, data receiver 215 may be, but is not limited to, a Bluetooth protocol data receiver or a WiFi data receiver. Based on the disclosure provided herein, one of ordinary skill in the art will recognize a variety of other data receivers that may be incorporated into music recognition device 201. Music recognition device 201 further includes an IO interface 231. IO interface 231 may support one or more IO protocols as are known in the art including, but not limited to, a USB IO protocol, an RS232 IO protocol, or an IEEE 1394 IO protocol. Music recognition device 201 also includes a graphical user interface 225 that is capable of driving and receiving information from a visual display 229. In some cases, music recognition device 201 may further include a communications network interface 221. This interface may support another form of wireless communication that is not supported by data receiver 215. As just one of many examples, communications network interface 221 may support communications via a cellular telephone network.

It should be noted that the various elements of music recognition device 201 are found in one or more existing consumer electronics devices. Thus, it may be possible to add a software or firmware upgrade to an existing consumer electronic device to achieve music recognition device 201. The software or firmware included with the existing consumer electronic device may cause, for example, a processor in the incorporating consumer electronic device to: continually receive the incoming data signal, retrieve a song identification from the incoming data signal, store at least a portion of the song identification to a memory of the consumer electronic device, and retrieve the stored identification sometime after the song which it identifies has stopped playing. This allows a user of music recognition device 201 to later retrieve a list of songs that they heard, and to determine the name and artist of one or more songs of interest.

In some cases, the software may further be executable by the processor to use a portion of the retrieved song identification to order a music media including a song identified by the identification sometime after the associated song has stopped playing. Thus, a user may be able to purchase the identified song in the form of a CD-ROM, an MP3 file, or some other audio medium at a time when it is convenient for the user sometime after the currently playing song has stopped. Yet further, in some cases the software may further be executable by the processor to time stamp the song identification with an approximate time when the associated song, or to store location information about where the associated song was heard. Thus, if the title and artist alone are not enough for the user to determine a song that is repeating in their head, the user will be provided with contextual information about when and where the user was exposed to the identified song. Based on the disclosure provided herein, one of ordinary skill in the art will recognize other contextual information that may be stored along with the song identification in accordance with various embodiments of the present invention.

Turning to FIG. 2c, a flow diagram 281 graphically represents a method for operating a music recognition device in accordance with various embodiments of the present invention. Following flow diagram 281, an audio signal is received by a listener from speaker 120 (block 283). Based on the availability of the audio signal, the listener may desire to enable a mobile music recognition device 250 that they have on their person (block 285). Where the mobile music recognition system 250 is enabled (block 285), it seeks to determine whether a data signal corresponding to the audio signal is being transmitted. Where the data signal is available, it is received by mobile music recognition device 250 (block 287). The data signal may be metadata associated with the transmitted audio signal As used herein, the term “metadata” is used in its broadest sense to mean any information in addition to the audio signal (e.g., music transmission) that is not critical to the audio signal, but provides information relevant to the audio signal. Thus, metadata corresponding to an audio signal may include, but is not limited to, the title of a currently playing song, the artist of the currently playing song, biographical information about the artist, purchase information relevant to locating and purchasing a medium including the currently playing song, the location of the source playing the audio signal, and/or the like. Based on the disclosure provided herein, one of ordinary skill in the art will recognize a variety of other information that may be included in a data signal in accordance with various embodiments of the present invention.

The aforementioned data signal may be repeatedly transmitted while the associated song is played via speaker 120. The transmission may include header or synchronization information that allows a receiving device to identify the beginning and end of the data signal. In some cases, where the data signal is transmitted in accordance with a particular network protocol, the header and synchronization data is provided in accordance with the particular protocol.

Once received (block 287), the data signal is parsed and desired information is extracted from the data signal (block 289). The extracted information is compared to the information received from a prior data signal to determine if the information is new (block 291). Data signals will continue to be received until the extracted information matches the information received from a preceding data signal. If the information extracted from the data signal is new, indicating a new song, then the data transmission time is also extracted (block 293). The data transmission time can include the date and time in hours and minutes. Additionally, the location tag or the information identifying the transmission source is extracted (block 295). The location tag could include information such as radio frequency, radio station call letters, compact disk player, an MP3 player, combinations of the aforementioned, and/or the like. These three pieces) of information, music identification, transmission time and transmission source, are recorded into the electronic device memory (block 297). In some cases, a small portion of the audio signal may also be recorded to the electronic device memory along with the identification information that allows a listener to later hear the small portion and use it to identify a particular song.

A user may desire to disable a mobile music recognition device 250, that they have on their person (block 299). If the user disables the mobile music recognition device 250, the music recognition device will no long receive or process data signals associated with audio signals. It will continue to receive audio signals, until a user again desires to enable a mobile recognition device 250.

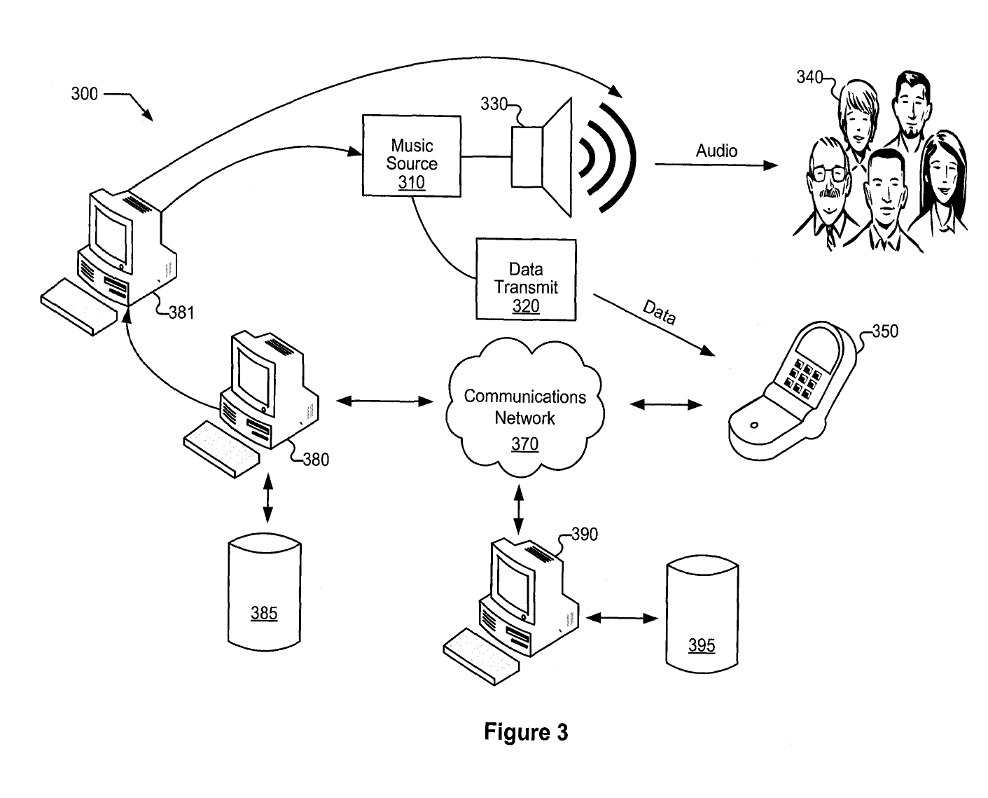

Turning to FIG. 3, a block diagram of a music recognition system 300 in accordance with some embodiments of the present invention is shown. In contrast to music recognition system 200 discussed above, music recognition system 300 is augmented to allow use of music-related services accessible via a music recognition device. Music recognition system 300 includes a music source 310 that is capable of transmitting an audio signal of a currently playing song via a speaker 330, and a digital signal carrying an identification of the currently playing song via a data transmitter 320. Music source 310 may include, but is not limited to, a radio frequency tuner, a compact disk player, an MP3 player, and/or combinations of the aforementioned. In one particular embodiment of the present invention, music source 310 is a satellite radio receiver. Based on the disclosure provided herein, one of ordinary skill in the art will recognize a myriad of music sources that may be used in relation to one or more embodiments of the present invention. The audio signal from speaker 330 may be transmitted such that it may be enjoyed by one person or a group of people 340 that may be located in a public or private location.

Data transmitter 320 may be any transmitter capable of disseminating informational messages (i.e., a data signal) via a wireless network. Thus, for example, data transmitter 320 may be a Bluetooth transmitter that is capable of disseminating information via a Bluetooth protocol network. In other cases, data transmitter 320 may be a WiFi transmitter that is capable of disseminating information via a wireless network that is 802.11 compliant. Based on the disclosure provided herein, one of ordinary skill in the art will recognize a variety of data transmitters and network protocols that may be used in relation to one or more embodiments of the present invention.

The data signal from data transmitter 320 is transmitted such that it may be received by one or more music recognition devices 350 that are located within range of the signal. Such music recognition devices 350 include capability to receive the data signal and to parse the identification of the currently playing song from the data signal. As previously discussed, the data signal may be transmitted via a particular wireless network protocol. In such cases, music recognition device 350 would include an interface allowing it to receive data via the particular protocol. In some cases, music recognition device 350 is a consumer electronic device that has been modified to perform one or more music recognition functions. Thus, music recognition device 350 may be incorporated in, for example, a cellular telephone, a personal digital assistant, a laptop computer, a digital music player, and a digital video player. Based on the disclosure provided herein, one of ordinary skill in the art will recognize a variety of consumer electronic devices into which music recognition device 350 may be incorporated. By incorporating music recognition device 350 with another common consumer electronic device, a user is not required to carry an additional device to receive the music recognition abilities discussed herein.

As previously suggested, a user may access other music-related services through a communication network 370 using music recognition device 350. Communication network may be any number of communication networks including, but not limited to, the Internet, a cellular telephone network, a virtual private network, combinations of the aforementioned, and/or the like. Based on the disclosure provided herein, one of ordinary skill in the art will recognize a variety of communications networks that may be used in relation to one or more embodiments of the present invention. To access other music-related services, a user may select a previously stored song identification, and select a purchase or other displayed command. Selection of the command causes an Internet browser application to execute on music recognition device 350, and directs the Internet browser application to a website capable of satisfying the command. Such websites may be accessed using a URL or other addressing mechanism. As shown, music recognition system 300 includes two accessible servers 380, 390 that are each associated with a respective database 385, 395 of accessible information. Each of servers 380, 390 may support different services or the same services from different suppliers. In addition a server 381 may be designed to provide feedback to one or both of music source 310 or the location at where music source 310 is accessed.

Thus, for example, where the command is a “purchase” command, the user may be directed to an Internet website where the selected song is available for purchase. The user is then able to purchase the selected song in a usable medium such as, for example, a CD ROM, an MP3 download, a ring tone, or the like. Based on the disclosure provided herein, one of ordinary skill in the art will recognize a variety of purchase options that may be satisfied in accordance with one or more embodiments of the present invention. To effectuate a purchase, an electronic request is sent from music recognition device to a server 380 supporting the accessed URL. Server 380 may be communicably coupled to other services via a processor 380 that is communicably coupled to a number of information sources, including database 385. Processor 380 may be any device capable of executing one or more instructions to obtain information from a database 385, a structured collection of data stored in memory.

Alternatively, where the command is a “more information” command, the user may be directed to a website containing more information about the particular song or an artist who composed the particular song. The additional information may include, but is not limited, artist information, fan club information, other related music information, such as related albums, related artists, and/or the like. This additional information may be available from another service supported by a different server as the aforementioned purchase server, or from the same service supported by the same purchase server.

Where a purchase or more information is requested via one or more of servers 380, 390, that information may be fed back to music source 310 and/or the location at which the music was listened to. Thus, for example, when the particular song is identified and stored in music recognition device 350 it may include an identification of the establishment where the song was heard and/or the music source 310 that played the song. When music recognition device 350 is used to effectuate a purchase of the song or to request additional information about the song via one or both of servers 380, 390, that information may be fed back to feedback server 381. In turn, feedback server 381 may pass that information to one or more recipients that use the information as market research to determine the types of music their customers like. Alternatively, or on addition, a payment may be made to one or both of music source 310 or the establishment as a referral for the purchase. Based on the disclosure provided herein, one of ordinary skill in the art will recognize a variety of other feedback and/or payment scenarios that may be implemented in accordance with one or more embodiments of the present invention.

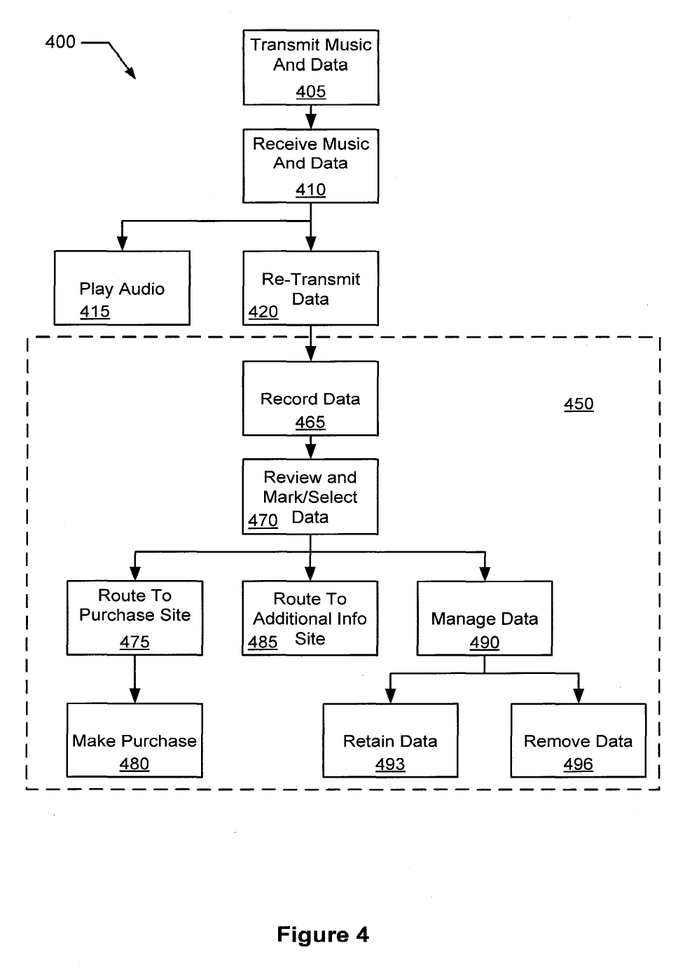

Turning to FIG. 4, a flow diagram 400 graphically represents a method for operating a music recognition system in accordance with some embodiments of the present invention. Following flow diagram 400, music and data signals (block 405) are transmitted by a music source, such as a digital music player and received (block 410) by a device, such as a radio receiver, wherein the music source is operable to transmit an audio signal (block 415) via the speaker. The music source also transmits the data signal (block 420), including an identification of a currently playing song, where it is received (block 460) by a music recognition device 350 (a personal computer, a notebook computer, a personal digital assistant, a cellular telephone, and/or the like) that is modified to include music recognition capability and uses a protocol selected from a group consisting of an 802.11 protocol. Once received by the music recognition device, the data is recorded (block 450) in the memory of the music recognition device 350. Based on the disclosure provided herein, one of ordinary skill in the art will recognize a variety of electronic device types and/or receivers that may incorporate the music recognition device in accordance with the various embodiments of the present invention.

A user may access the identification information stored in the memory of the music recognition system (block 450) for the purpose of managing all of the identifications or to use portions of the identifications. Sorting through each identification, a user may choose to mark a specific identification for use at a later time (block 470). An identification may be marked by pressing a button execute instructions stored in the processor memory 219 of the music recognition system (block 450) that adds a recognition character to the identification. At a later time, a user may again execute instructions stored in the processor memory 219, including performing a search to locate and display all previously marked identifications. Upon finding the desired identification, a user may want to select it for further use (block 470). Once selected, a portion of the identification may be used to order music media, including a song identified by the identification. The search request is routed to the purchase site (block 475) to locate the desired music selection. When found, a user may choose to complete the music order purchase (block 480). Again, a user may choose to use a portion of the identification to search alternate server databases or Internet websites, by executing instructions stored in the processor memory 219, such as sites containing additional artist information, artist fan clubs, or access related information pertaining to other music selections the user may find of interest (block 485).

A user may also desire to manage an increasing number of music identifications recorded in an electronic device memory (block 490). While reviewing each identification, a user may desire to retain each identification for future use (block 493). Or, if an identification is not needed, it can be permanently removed (block 496) by executing instructions stored in the processor memory 219 of the music recognition system (block 450).

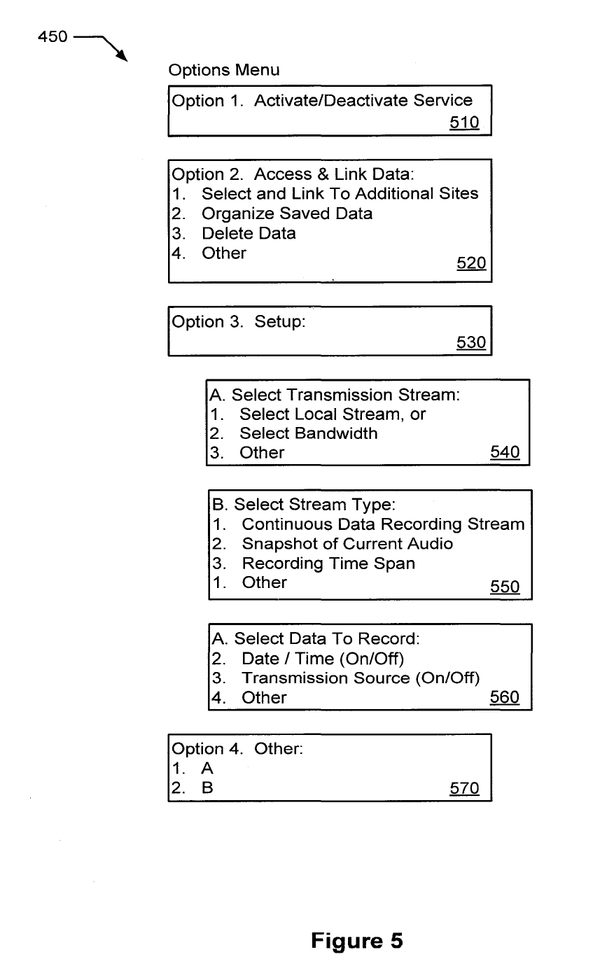

Turning to FIG. 5, a flow diagram depicts some additional detail of the method discussed in FIG. 4. A music recognition system (block 450) in an electronic device 350 may include a menu system capable of operating and managing identifications. Menu navigation and menu item selection may be controlled by buttons on the electronic device 350, which, when pressed, execute instructions stored in the processor memory 219. Electronic device 350 may be any processor-based device including, but not limited to, a digital music player, a digital video player, a laptop computer, a personal digital assistant, a cellular telephone, and/or the like. Based on the disclosure provided herein, one of ordinary skill in the art will recognize a variety of electronic device types and/or receivers that may incorporate the music recognition device in accordance with the various embodiments of the present invention.

Option 1 (block 510) of the music recognition menu system (block 450) enables a user to activate or deactivate the music recognition system. While navigating the menu system, a user can press a button on the electronic device to execute instructions stored in the processor memory 219 that acts as a toggle to activate or deactivate the system. Activating the system causes the electronic device 350 to receive and record music data. Deactivating the system disables music data reception.

Option 2 enables a user to use and manage identifications (block 520). Upon reviewing each identification, a user may choose to select a specific identification and use it to search other Internet locations for related information, as aforementioned. A user may also choose to manage saved identifications by executing instructions stored in the processor memory 219 to reorganize and/or group identifications for more convenient future access. Or, a user may choose to remove identifications no longer needed or those of no use.

Option 3 enables a user to configure the music recognition system (block 530) by selecting the location from which to receive music data (block 540), selecting the identification recording type (block 550), and/or selecting the data types the user desires to record (block 560). A user may desire to select the location from which to receive music data transmissions. Source options may include a specific radio frequency bandwidth, a local compact disk player, a local stereo transmission, and/or the like. Based on the disclosure provided herein, one of ordinary skill in the art will recognize a variety of music transmission device types and/or receivers that may be utilized in accordance with the various embodiments of the present invention.

Identification recording options (block 550) could include enabling a continuous identification recording stream, receiving and recording a “snapshot” of a song wherein the associated identification is recorded, specifying a time range where identifications are recorded, and/or the like. Enabling a continuous stream will cause identifications to be received and recorded indefinitely until the option is disabled. When a user wants to know the artist and title of a desired song, but may not know when it will be transmitted (played), this option may be enabled until such time as the tune is recognized or a user chooses to disable the continuous data stream by executing instructions stored in the processor memory 219.

Upon hearing a desirable song, a user may choose to take a “snapshot” of the music data signal being transmitted. A user may push a button or make a menu selection to execute instructions stored in the processor memory 219 to immediately enable the music recognition system (block 450) to record the data signal being transmitted. Music data signals will continue to be received until a new identification is received. Once a new identification is received, the first identification is recorded and the music recognition system (block 450) would then disable any further data signal receptions. This option also limits the number of identifications stored in memory that must be managed at a later time.

A user may desire the flexibility to specify a limited time period to record identifications by executing instructions stored in the processor memory 219. This would limit the amount of data received that would require future management, especially if a user knows that a specific music identification will occur during a specified time span. Additionally, a user may adjust the time settings to record during a period of time that a user may not be available to activate or deactivate the device. For example, a user may adjust the time settings to automatically enable the music recognition system at 8 am and disable at 12 pm, when the user may be physically distant from electronic device 350 by executing instructions stored in the processor memory 219.

A user may desire to control the type of information recorded (block 560) from a data signal for any identification. A user may disable or enable options to record the date and/or time of music data transmission, a transmission source, and/or the like, by executing instructions stored in the processor memory 219. A date and/or time stamp provides yet more information to enable a user to more quickly locate a specific identification for a desired song. For example, a user has enabled the music recognition system, and throughout the course of a day hears a desirable song while at a certain location, such as a restaurant, between noon and 1 pm. At the user's convenience, they may search all identifications, recorded between noon and 1 pm, to more easily locate the related identification. Additionally, a user may choose to disable the date and/or time stamp to limit the amount of data recorded in the electronic device 350 memory by executing instructions stored in the processor memory 219. Also, other options (block 570) may provide the user further flexibility in receiving, recording and managing identifications.

In conclusion, the present invention provides novel systems, devices, methods and arrangements related to music recognition. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A cellular telephone, wherein the cellular telephone comprises:
a data receiver, wherein the data receiver is operable to receive a data signal, and wherein the data signal includes an identification of a currently playing song, the identification comprising a location at which the currently playing song is played;
a processor;
a memory, wherein the memory includes instructions executable by the processor to:
parse the data signal and to cause the identification to be stored to the memory;
and wherein the memory includes a portion allocatable to receive at least a portion of the identification and to maintain the portion of the identification after the currently playing song has terminated.

2. A music recognition device, wherein the music recognition device comprises:
a data receiver, wherein the data receiver is operable to receive a data signal, and wherein the data signal includes an identification of a currently playing song, wherein the identification includes a portion of an audio signal of the currently playing song;
a memory;
a processor, wherein the memory includes instructions executable by the processor to:
parse the data signal and to cause the identification to be stored to the memory;
and wherein at least a portion of the identification is maintained in the memory after the currently playing song has terminated.

3. The music recognition device of claim 2, wherein the identification includes a song title and artist.

4. The music recognition device of claim 3, wherein the identification further includes a location at which the currently playing song was played.

5. The music recognition device of claim 2, wherein the music recognition device includes location circuitry operable to provide a location of the music recognition device, and the location of the music recognition device is stored in relation to the identification.

6. The music recognition device of claim 2, wherein the memory further includes instructions executable by the processor to store a time stamp in relation to the identification, wherein the time stamp indicates an approximate time when the currently playing song was playing.

7. The music recognition device of claim 2, wherein the music recognition device is incorporated into an electronic device selected from a group consisting of: a cellular telephone, a personal digital assistant, a laptop computer, a digital music player, and a digital video player.

8. The music recognition device of claim 2, wherein the data receiver is a wireless receiver.

9. The music recognition device of claim 8, wherein the wireless receiver is able to receive information using a protocol selected from a group consisting of: an 802.11 protocol, and a Bluetooth protocol.

10. A music recognition system, the system comprising:
a music source, wherein the music source includes a speaker and a wireless data transmitter, wherein the music source is operable to transmit a data signal via the wireless data transmitter, wherein the music source is operable to transmit an audio signal via the speaker, wherein the audio signal is a currently playing song, and wherein the data signal includes an identification of a currently playing song, and wherein the identification includes a data transmission time.

11. The music recognition system of claim 10, wherein the music source is selected from a group consisting of: a digital music player, and a radio receiver.

12. The music recognition system of claim 10, wherein the identification includes a song title and artist.

13. The music recognition system of claim 11, wherein the identification further includes a location of the music source.

14. The music recognition system of claim 10, wherein the wireless data transmitter is able to transmit information using a protocol selected from a group consisting of: an 802.11 protocol, and a Bluetooth protocol.

15. A method for music recognition, the method comprising:
providing a music recognition device, wherein the music recognition device includes:
a data receiver; and
a memory;
receiving a data signal at the data receiver, wherein the data signal includes an identification of a currently playing song, wherein the identification includes a portion of an audio signal of the currently playing song;
storing at least a portion of the identification to the memory; and
maintaining the portion of the identification in the memory after the currently playing song has stopped.

16. The method for music recognition of claim 15, wherein the method further includes:
accessing the portion of the identification from the memory; and
using a portion of the identification to order a music media including a song identified by the identification after the currently playing song has stopped.

17. The method for music recognition of claim 15, wherein the portion of the identification includes a song title and artist.

18. The method of claim 15, wherein the method further comprises:
storing a location where the user was exposed to the currently playing song to the memory.

19. The method of claim 15, wherein the method further comprises:
storing an approximate time when the currently playing song was playing to the memory.

20. The method of claim 15, wherein the music recognition device is incorporated into an electronic device selected from a group consisting of: a cellular telephone, personal digital assistant, laptop computer, digital music player, and digital video player.

21. (canceled)
